(19) United States
(12) Patent Application Publication
(10) Pub. No.: US 2024/0303587 A1
(43) Pub. Date: Sep. 12, 2024

(54) LOGISTICS QUOTATION SYSTEM APPLIED TO CUSTOMER END AND OPERATION METHOD FOR OPERATING THE SAME

(71) Applicants: Zhen-sheng Wang, SANTA FE SPRINGS, CA (US); Ze-Nong Wang, SANTA FE SPRINGS, CA (US); Ze-Feng Wang, SANTA FE SPRINGS, CA (US)

(72) Inventors: Zhen-sheng Wang, SANTA FE SPRINGS, CA (US); Ze-Nong Wang, SANTA FE SPRINGS, CA (US); Ze-Feng Wang, SANTA FE SPRINGS, CA (US)

(21) Appl. No.: 18/118,673

(22) Filed: Mar. 7, 2023

(51) Int. Cl. G06Q 10/0834

(52) U.S. Cl. CPC G06Q 10/08345

(57) ABSTRACT

A logistics quotation system and operation method for the customer end include a form module, an upload module, a quotation module and a confirmation module, the form module includes a list section, a filling section and an inquiry section, the upload module It is connected with the operation end system and includes a transmission section. The quotation module includes a sorting display section and a selection section. The confirmation module is connected with the operation end system and includes a confirmation section and an order transmission section. Through the operation of each module, a system that allows customers to automatically calculate the amount that matches the transportation mode after providing the inquiry demand, and to agree to the quotation online. Compared with the previous technology, the present invention greatly reduces the wasteful cost of intermediate and lengthy procedures, and provides customers with a faster and more accurate quotation system.

### BACKGROUND OF THE INVENTION

### 1. Fields of the Invention

The present invention relates to a field of shopping logistics, in particular to a logistics quotation system and operation method applied to customer end.

### 2. Descriptions of Related Art

For the past few years, along with the continuous popularization of the internet, people's habit of buying and selling things through the internet has gradually increased.

There are a lot of procedures to be carried out to purchase products from different regions and countries. Different transportation operation modes and steps during the online purchase, require and generate different amounts of money. These will affect the decisions of the consumers to purchase specific products. Therefore, it is very important to know the amount of shopping and logistics before putting their orders.

However, most modern transportation logistics still use manual inquiries to ask the customer to get the quotation, the desired transportation mode, the price and process from the operation end, such as using letter paper, telephone, email, SMS and other methods. It is necessary to manually inquire one by one, and then wait for the operation end to match the transportation mode, and calculate the required amount. The results then sent back to the customer via the same method, thereby wasting a lot of time.

The present invention intends to provide a logistics quotation system and operation method applied to customer end, so as to eliminate the shortcomings mentioned above.

### SUMMARY OF THE INVENTION

The present invention relates to a logistics quotation system applied to customer end, and comprises a form module, an uploading module, a quotation module, and a confirmation module connected with each other. The form module includes a list section, a filling section and an inquiry section connected to each other. The list section provides a standard list to a customer. The filling section provides the customer to fill out and edit the standard list. The inquiry section provides the customer to create an inquiry form after filling out and editing the standard list.

The uploading module is connected to an operation end system and includes a transmission section. The transmission section transmits the inquiry form to the operation end system.

The quotation module includes a sorting display section and a selection section connected to each other. The sorting display section sorts and displays a price information calculated and formed by the operation end system to the customer. The selection section provides the customer with the price information such that the customer makes selections to form a confirmation form.

The confirmation module is connected with the operating system, and includes a confirmation section and an order transmission section connected to each other. The confirmation section provides the customer to confirm or to cancel the confirmation order. The order transmission section edits the confirmed confirmation form confirmed by the customer to be an order which is sent to the operation end system.

The present invention also provides a method for operating the logistics quotation system applied to customer end, and comprises the following steps:
a filling step: a form module of a customer end system providing a standard form to a customer to be filled out and edited, the form module creating an inquiry form by the standard form and sending the inquiry form to an uploading module;
an uploading step: the inquiry form sent to the uploading module being transmitted to the operation end system to make an inquiry;
a calculation step: the operating end system matching transportation modes according to the inquiry form, and calculating required amount of each transportation mode, and sending the matched transportation mode and the amount to the customer end system;
a quotation step: the operation end system transmitting the matched transportation mode and the amount to the quotation module, the quotation module managing and displaying the price information for the customer to select, the quotation module creating a confirmation form after the customer selects the transportation mode and the amount, and sending the confirmation form to a confirmation module, and
a confirmation step: the confirmation module asking the customer to confirm or to cancel the confirmation form, if the customer confirms the confirmation form, the confirmation module edits the confirmation form to be an order which is sent to the operation end system.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the components of the logistics quotation system applied to customer end of the present invention;

FIG. 2 shows the flow chart of operation of the logistics quotation system applied to customer end of the present invention, and

FIG. 3 shows the steps of the method for operating the logistics quotation system applied to customer end.

### DETAILED DESCRIPTION OF THE PREFERRED EMBODIMENT

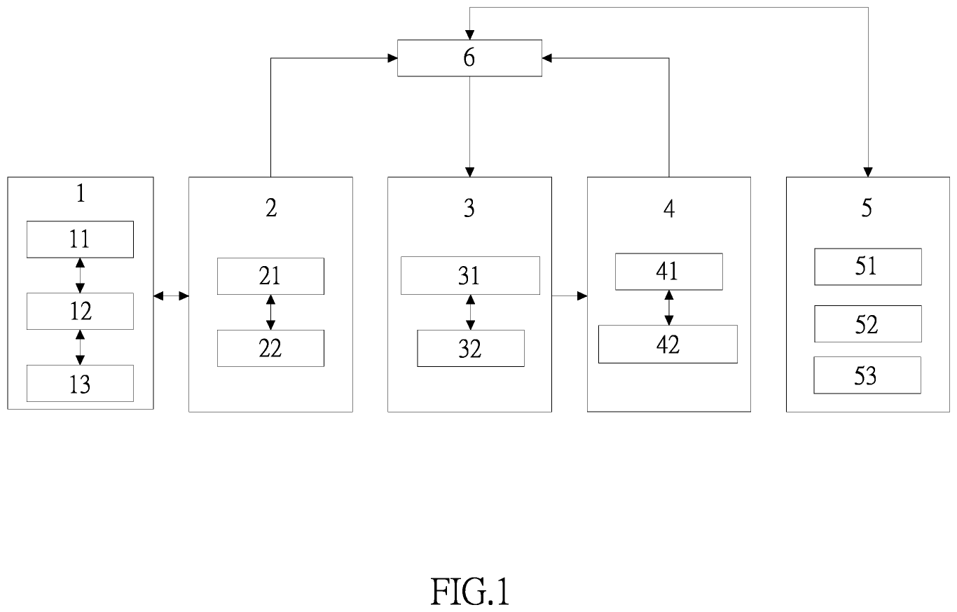

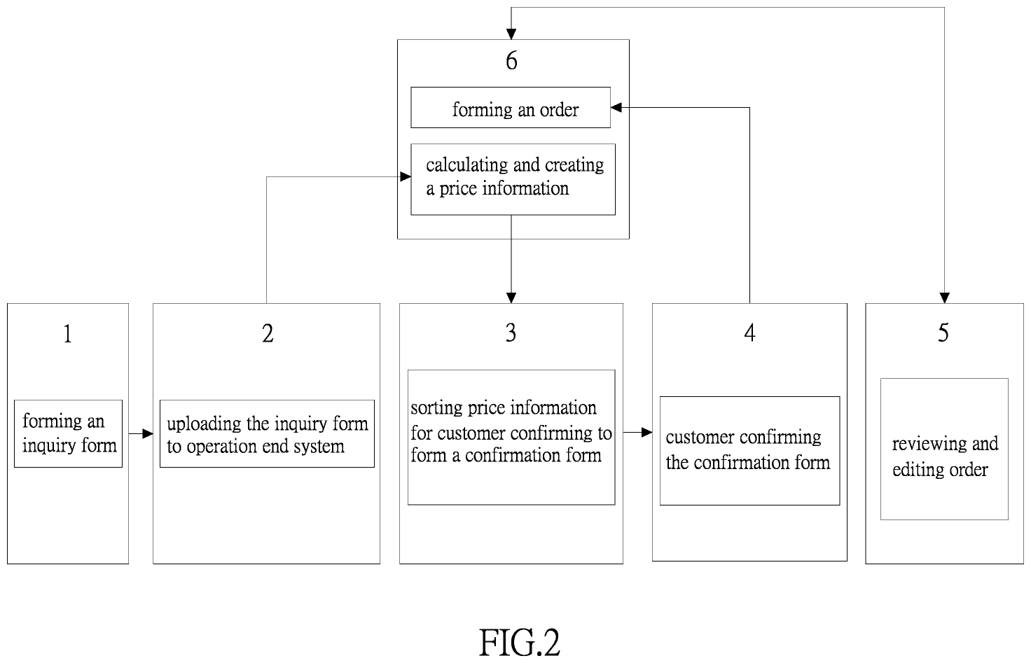

Referring to FIGS. 1 and 2, the logistics quotation system applied to customer end of the present invention comprises a form module 1, an uploading module 2, a quotation module 3, and a confirmation module 4. The form module 1 includes a list section 11, a filling section 12 and an inquiry section 13 connected to each other. The list section 11 provides a standard list to a customer, and the filling section 12 provides the customer to fill out and edit the standard list. The inquiry section 13 provides the customer to create an inquiry form after filling out and editing the standard list.

The uploading module 2 is connected to an operation end system 6 and includes a transmission section 21. The transmission section 21 transmits the inquiry form to the operation end system 6.

The quotation module 3 includes a sorting display section 31 and a selection section 32 connected to each other. The sorting display section 31 sorts and displays a price information calculated and formed by the operation end system 6 to the customer. The selection section 32 provides the customer with the price information such that the customer makes selections to form a confirmation form.

The confirmation module 4 is connected with the operating system 6, and includes a confirmation section 41 and an order transmission section 42 connected to each other. The confirmation section 41 provides the customer to confirm or to cancel the confirmation order. The order transmission section 42 edits the confirmed confirmation form confirmed by the customer to be an order which is sent to the operation end system 6.

Furthermore, as shown in FIG. 1, the transmission section 21 of the uploading module 2 is connected to a recording section 22 which records contents of the inquiry form. The recording section 22 prevents loss of the information that the customer put into the system when the computer is accidentally shut off.

As shown in FIGS. 1 and 2, an order record module 5 is included and which includes a query section 51. The query section 51 provides the customer to record and review the order.

The order record module 5 includes a modifying section 52 that is connected to the query section 51. The modifying section 52 provides the customer to modify the order before the operation end system 6 starts to process the order so as to prevent the customer from sending an incorrect order.

As shown in FIG. 1, the order record module 5 includes a cancel section 53 which is connected to the query section 51. The cancel section 53 provides the customer to cancel the order before the operation end system 6 starts to process the order.

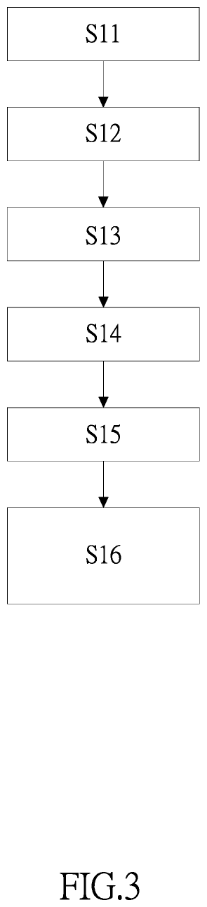

As shown in FIGS. 1 to 3, a method for operating logistics quotation system applied to customer end comprises a filling step S11, an uploading step S12, a calculation step S13, a quotation step S14 and a confirmation step S15.

The filling step S11 is that the form module 1 of the customer end system provides a standard form to a customer to be filled out and edited. The form module 1 creates an inquiry form by the standard form and sends the inquiry form to the uploading module 2.

The uploading step S12 is that after completing the filling step S11, the inquiry form that is sent to the uploading module 2 is transmitted to the operation end system 6 to make an inquiry.

The calculation step S13 is that after completing the uploading step S12, the operating end system 6 matches transportation modes according to the inquiry form, and calculates required amount of each transportation mode. The matched transportation mode and the amount are then sent to the customer end system.

The quotation step S14 is that after completing the calculation step S13, the operation end system 6 transmits the matched transportation mode and the amount to the quotation module 3. The quotation module 3 manages and displays the price information for the customer to select. The quotation module 3 creates a confirmation form after the customer selects the transportation mode and the amount. The confirmation form is then set to a confirmation module 4.

The confirmation step S15 is that after completing the quotation step S14, the confirmation module 4 asks the customer to confirm or to cancel the confirmation form. If the customer confirms the confirmation form, the confirmation module 4 edits the confirmation form to be an order which is sent to the operation end system 6.

The uploading module 2 in the uploading step S12 further includes a recording section 22 which records contents of the inquiry form so as to prevent information loss if the computer is accidentally shut off.

The method further comprises an order processing step S16, wherein the order processing step S16 processes the order after the confirmation step S15 is completed.

In practice, after the customer fills out the standard form provided from the customer end system and confirms to send out the standard form, the operation end system will match the transportation modes and calculate the required amount of each transportation mode, and then sent to the customer. The customer then decides to accept the quotation, or to reject the quotation.

While we have shown and described the embodiment in accordance with the present invention, it should be clear to those skilled in the art that further embodiments may be made without departing from the scope of the present invention.

What is claimed is:

1. A logistics quotation system applied to customer end, comprising:
a form module, an uploading module, a quotation module, and a confirmation module connected with each other, the form module including a list section, a filling section and an inquiry section connected to each other, the list section providing a standard list to a customer, the filling section providing the customer to fill out and edit the standard list, the inquiry section providing the customer to create an inquiry form after filling out and editing the standard list;
the uploading module connected to an operation end system and including a transmission section, the transmission section transmitting the inquiry form to the operation end system;
the quotation module including a sorting display section and a selection section connected to each other, the sorting display section sorting and displaying a price information calculated and formed by the operation end system to the customer, the selection section providing the customer with the price information such that the customer makes selections to form a confirmation form, and
the confirmation module connected with the operating system, the confirmation module including a confirmation section and an order transmission section connected to each other, the confirmation section providing the customer to confirm or to cancel the confirmation order, the order transmission section editing the confirmed confirmation form confirmed by the customer to be an order which is sent to the operation end system.

2. The logistics quotation system applied to customer end as claimed in claim 1, wherein the transmission section of the uploading module is connected to a recording section which records contents of the inquiry form.

3. The logistics quotation system applied to customer end as claimed in claim 1 further comprising an order record module which includes a query section, the query section provides the customer to record and review the order.

4. The logistics quotation system applied to customer end as claimed in claim 3, wherein the order record module includes a modifying section that is connected to the query section, the modifying section provides the customer to modify the order before the operation end system starts to process the order.

5. The logistics quotation system applied to customer end as claimed in claim 3, wherein the order record module includes a cancel section which is connected to the query section, the cancel section provides the customer to cancel the order before the operation end system starts to process the order.

6. A method for operating logistics quotation system applied to customer end, and comprising:
a filling step: a form module of a customer end system providing a standard form to a customer to be filled out and edited, the form module creating an inquiry form by the standard form and sending the inquiry form to an uploading module;
an uploading step: the inquiry form sent to the uploading module being transmitted to the operation end system to make an inquiry;
a calculation step: the operating end system matching transportation modes according to the inquiry form, and calculating required amount of each transportation mode, and sending the matched transportation mode and the amount to the customer end system;
a quotation step: the operation end system transmitting the matched transportation mode and the amount to the quotation module, the quotation module managing and displaying a price information for the customer to select, the quotation module creating a confirmation form after the customer selects the transportation mode and the amount, and sending the confirmation form to a confirmation module, and
a confirmation step: the confirmation module asking the customer to confirm or to cancel the confirmation form, if the customer confirms the confirmation form, the confirmation module edits the confirmation form to be an order which is sent to the operation end system.

7. The method as claimed in claim 6, wherein the uploading module in the uploading step includes a recording section which records contents of the inquiry form.

8. The method as claimed in claim 6 further comprising an order processing step, the order processing step processes the order after the confirmation step is completed.
